(19) United States
(12) Patent Application Publication
(10) Pub. No.: US 2012/0158182 A1
(43) Pub. Date: Jun. 21, 2012

(54) WALKING CONTROL APPARATUS AND METHOD OF ROBOT

(75) Inventors: Ju Suk Lee, Suwon-si (KR); Kyung Shik Roh, Seongnam-si (KR); Woong Kwon, Seongnam-si (KR); Jae Ho Park, Suwon-si (KR)

(73) Assignee: Samsung Electronics Co., Ltd., Suwon-si (KR)

(21) Appl. No.: 13/280,586

(22) Filed: Oct. 25, 2011

(30) Foreign Application Priority Data
Dec. 20, 2010 (KR) 10-2010-0130841

(51) Int. Cl. G05B 15/00

(52) U.S. Cl. 700/261; 901/16

(57) ABSTRACT

A walking control apparatus and method of a robot. The walking control method include confirming a swing leg and a support leg by judging a walking state of the robot when a walking velocity of the robot and a walking command are received by the robot, generating reference pitch knot points of a hip joint unit of the swing leg based on the walking state and the walking velocity of the robot, generating a target pitch angle trajectory of the hip joint unit of the swing leg using the reference pitch knot points, calculating torques tracking the target pitch angle trajectory, and outputting the torques to the hip joint unit of the swing leg to control the walking velocity of the robot. The walking velocity of the robot is rapidly and easily changed by adjusting at least one of a step length and a step time.

### CROSS-REFERENCE TO RELATED APPLICATIONS

This application claims the benefit of Korean Patent Application No. 2010-0130841, filed on Dec. 20, 2010 in the Korean Intellectual Property Office, the disclosure of which is incorporated herein by reference.

### BACKGROUND

1. Field

Embodiments relate to a walking control apparatus and method of a robot in which driving of joint units provided on a plurality of legs of the robot is controlled so as to achieve stable walking of the robot.

2. Description of the Related Art

In general, robots are machines which have a joint system similar to that of a human and perform the same motions as those of human hands and legs using such a joint system.

Development of industrial robots for automation and unmanned operation of production in factories were the first to be introduced. Recently, vigorous development of service robots to supply service to humans is underway.

Such service robots supply service to humans while performing walking similar to walking of humans. Thereby, research and development of walking of the robots is actively progressing.

As walking control methods of robots, there are a position-based Zero Moment Point (hereinafter, referred to as ZMP) control method which tracks a target position of a robot joint, and a torque-based dynamic walking control method and a Finite State Machine (hereinafter, referred to as FSM) control method which track a target torque of a robot joint.

In the ZMP control method, walking direction, walking stride, and walking velocity of a robot are set in advance so as to satisfy a ZMP constraint. A ZMP constraint might be, for example, a condition that a ZMP is present in a safety region within a support polygon formed by supporting leg(s) (if the robot is supported by one leg, this means the region of the leg, and if the robot is supported by two legs, this means a region set to have a small area within a convex polygon including the regions of the two legs in consideration of safety). In the ZMP control method, walking patterns of the respective legs corresponding to the set factors are created, and walking trajectories of the respective legs are calculated based on the walking patterns.

Further, positions of joints of the respective legs are calculated through inverse kinematic calculation of the calculated walking trajectories, and target control values of the respective joints are calculated based on current positions and target positions of the respective joints.

In the torque-based dynamic walking control method, servo control in which respective legs track calculated walking trajectories per control time is achieved. That is, during walking, whether or not positions of the respective legs precisely track the walking trajectories according to the walking patterns is detected, and if some legs deviate from the walking trajectories, torques of motors are adjusted so that the respective legs precisely track the walking trajectories.

In the FSM control method, instead of tracking positions per control time, a finite number of operating states (herein, the states mean states in a finite state machine) of a robot is defined in advance, target torques of respective joints are calculated with reference to the respective operating states during walking, and the joints are controlled so as to track the target torques.

Such an FSM control method allows a robot to take various poses through transition between operating states during walking but selects the operating states from among the finite number of operating states, thereby causing the robot to perform a separate motion to maintain balance regardless of walking motions to carry out its duty.

On the other hand, the ZMP control method is a position-based control method and thus achieves precise position control, but needs to perform precise angle control of the respective joints and thus requires a high servo gain. Thereby, the ZMP control method requires high current and thus has low energy efficiency and high stiffness of the joints, thereby applying high impact if the robot collides with surroundings.

Further, the ZMP control method needs to avoid kinematic singularities in order to calculate angles of the respective joints through inverse kinematics from the given center of mass and walking patterns of legs, thereby causing the robot to take a pose with knees bent at all times during walking and thus to have an unnatural gait differing from that of a human.

The torque-based dynamic walking control method needs to solve the dynamic equation for stable walking. However, since the dynamic equation of a robot having legs with 6 degrees of freedom to achieve a random direction in a space is excessively complex, the torque-based dynamic walking control method is actually applied only to a robot having legs with 4 or less degrees of freedom.

The FSM control method achieves control of a robot by torque commands and is applied to an elastic mechanism and thus has high energy efficiency and low stiffness of the joints, thereby being safe with respect to surroundings. However, the FSM control method has difficulty achieving precise position control, thus having difficulty performing a precise whole body motion, such as ascending of stairs or avoiding of an obstacle.

Robots using the above walking control methods are disadvantageous in that a walking motion is unstable if the robot walks while adjusting a walking velocity and it takes long time to calculate torques to achieve optimal walking.

### SUMMARY

Therefore, it is an aspect of embodiments to provide a walking control apparatus and method of a robot in which a walking velocity is changed by adjusting at least one of a step length and a step cycle of each leg.

It is another aspect of an embodiment to provide a walking control apparatus and method of a robot in which stable walking of the robot is maintained.

Additional aspects of embodiments will be set forth in part in the description which follows and, in part, will be obvious from the description, or may be learned by practice of the embodiments.

In accordance with an aspect of an embodiment, a walking control apparatus of a robot includes an input unit to receive a walking velocity of the robot, hip joint units respectively provided on a plurality of legs of the robot, a pose detection unit to detect a pose of the robot, a walking state judgment unit to judge a walking state from the pose of the robot, a target angle trajectory generation unit to confirm a swing leg and a support leg based on the walking state, to generate reference knot points of the hip joint unit of the swing leg based on the walking velocity, and to generate target angle trajectories of the hip joint unit using the reference knot points, a torque calculation unit to calculate torques tracking the target angle trajectories, and a control unit to output the torques to the hip joint unit to control the walking velocity of the robot.

The target angle trajectory generation unit may determine a first angle of the hip joint unit when the foot of the swing leg leaves the ground and a second angle of the hip joint unit when the foot of the swing leg contacts the ground based on the walking velocity, set the first angle to be a first reference pitch knot point of the hip joint unit and set the second angle to be a second reference pitch knot point of the hip joint unit.

The walking control apparatus may further include a center of mass (COM) detection unit to detect the COM of the robot, and the target angle trajectory generation unit may calculate an offset angle based on the first angle and the COM, and respectively reflect the offset angle in the first reference pitch knot point of the hip joint unit and the second reference pitch knot point of the hip joint unit.

The walking control apparatus may further include a knot point compensation value calculation unit to calculate a pitch knot point compensation value of the hip joint unit by judging a variation of the COM in the X-axis direction and comparing the variation of the COM in the X-axis direction with a reference variation of the COM in the X-axis direction, and the target angle trajectory generation unit may generate target pitch knot points by compensating for the first reference pitch knot point and the second reference pitch knot point, in which the offset angle is reflected, with the pitch knot point compensation value.

The walking control apparatus may further include ankle joint units respectively provided on the plurality of legs of the robot, and the target angle trajectory generation unit may generate a first reference pitch knot point and a second reference pitch knot point of the ankle joint unit based on an angle of the ankle joint unit when the robot stands erect, the first angle, the second angle and the offset angle, and generate a target pitch angle trajectory of the ankle joint unit by connecting the first reference pitch knot point and the second reference pitch knot point of the ankle joint unit by a spline.

The target angle trajectory generation unit may generate a target pitch angle trajectory of the hip joint unit by connecting the first reference pitch knot point and the second reference pitch knot point of the hip joint unit by a spline, and adjust a cycle of the target pitch angle trajectory of the hip joint unit based on the walking velocity.

The cycle of the target pitch angle trajectory of the hip joint unit may correspond to a step time during which one step is performed during walking of the robot, and an amplitude of the target pitch angle trajectory of the hip joint unit may correspond to a step length of the one step.

The pose detection unit may include an F/T detection unit to detect force transmitted to the feet of the robot.

In accordance with another aspect of an embodiment, a walking control method of a robot includes confirming a swing leg and a support leg of the robot by judging a walking state of the robot when a walking velocity of the robot and a walking command are received by the robot, generating reference pitch knot points of a hip joint unit of the swing leg based on the walking state and the walking velocity of the robot, generating a target pitch angle trajectory of the hip joint unit of the swing leg using the reference pitch knot points, calculating torques tracking the target pitch angle trajectory, and outputting the torques to the hip joint unit of the swing leg to control the walking velocity of the robot.

The generation of the reference pitch knot points of the hip joint unit of the swing leg may include determining a first angle of the hip joint unit when the foot of the swing leg leaves the ground and a second angle of the hip joint unit when the foot of the swing leg contacts the ground based on the walking velocity, and setting the first angle to be a first reference pitch knot point of the hip joint unit and setting the second angle to be a second reference pitch knot point of the hip joint unit.

The generation of the first and second reference pitch knot points may include obtaining an erect standing angle of the hip joint unit under the condition that the robot stands erect, and reflecting the erect standing angle of the hip joint unit in the first and second reference pitch knot points.

The walking control method may further include storing an offset angle based on the first angle and the center of mass (COM) of the robot in advance, and reflecting the offset angle, stored in advance, in the first reference pitch knot point of the hip joint unit and the second reference pitch knot point of the hip joint unit.

The walking control method may further include detecting the center of mass (COM) of the robot, calculating an offset angle based on the first angle and the COM, and reflecting the offset angle in the first reference pitch knot point of the hip joint unit and the second reference pitch knot point of the hip joint unit, respectively.

The walking control method may further include obtaining an erect standing angle of an ankle joint unit under the condition that the robot stands erect, generating a first reference pitch knot point of the ankle joint unit based on the erect standing angle of the ankle joint unit, the first angle and the offset angle, generating a second reference pitch knot point of the ankle joint unit based on the erect standing angle of the ankle joint unit, the second angle and the offset angle, and generating a target pitch angle trajectory of the ankle joint unit by connecting the first reference pitch knot point and the second reference pitch knot point of the ankle joint unit by a spline.

The generation of the target pitch angle trajectory of the hip joint unit may be carried out by connecting the first reference pitch knot point and the second reference pitch knot point of the hip joint unit by a spline, and a cycle of the target pitch angle trajectory of the hip joint unit may be adjusted based on the walking velocity.

The cycle of the target pitch angle trajectory of the hip joint unit may be adjusted so as to correspond to a step time during which one step is performed during walking of the robot, an amplitude of the target pitch angle trajectory of the hip joint unit may be adjusted so as to correspond to a step length of the one step, and the control of the walking velocity may include adjusting at least one of the step time and the step length.

The generation of the target pitch angle trajectory of the hip joint unit may include detecting the center of mass (COM) of the robot, judging a variation of the COM in the X-axis direction, calculating a pitch knot point compensation value of the hip joint unit by comparing the variation of the COM in the X-axis direction with a reference variation of the COM in the X-axis direction, and generating target pitch knot points of the hip joint unit by compensating for the first reference pitch knot point and the second reference pitch knot point with the pitch knot point compensation value.

The walking control method may further include detecting the center of mass (COM) of the robot, judging a variation of the COM in the Y-axis direction, calculating a roll knot point compensation value of the hip joint unit by comparing the variation of the COM in the Y-axis direction with a reference variation of the COM in the Y-axis direction, generating reference roll knot points of the hip joint unit in the next step based on the walking state of the robot, and generating target roll knot points of the hip joint unit by compensating for the reference roll knot points with the roll knot point compensation value.

The walking control method may further include generating reference roll knot points and reference pitch knot points of the hip joint unit of the support leg which will support the ground.

The walking control method may further include detecting the center of mass (COM) of the robot, judging a variation of the COM in the X-axis direction, calculating a pitch knot point compensation value based on the variation of the COM in the X-axis direction, calculating a roll knot point compensation value based on a variation of the COM in the Y-axis direction, generating target roll knot points of the hip joint unit of the support leg by compensating for the reference roll knot points with the roll knot point compensation value, and generating target pitch knot points of the hip joint unit of the support leg by compensating for the reference pitch knot points with the pitch knot point compensation value.

The judgment of the walking state may include detecting load of feet of the robot, judging a leg, the load of which is detected, to be the support leg which contacts the ground, and judging a leg, the load of which is not detected, to be the swing leg which does not contact the ground.

### BRIEF DESCRIPTION OF THE DRAWINGS

These and/or other aspects of embodiments will become apparent and more readily appreciated from the following description of the embodiments, taken in conjunction with the accompanying drawings of which:

FIG. 1 is an exemplary view of a robot in accordance with an embodiment;

FIG. 2 is an exemplary view illustrating structures of joints of the robot in accordance with an embodiment;

FIG. 3 is a control block diagram of a walking control apparatus of the robot in accordance with an embodiment;

FIGS. 4A and 4B are exemplary views illustrating variations of the center of mass of the robot in accordance with an embodiment;

FIG. 5 is a view illustrating a detailed configuration of a walking state judgment unit of the walking control apparatus of the robot in accordance with an embodiment;

FIG. 6 is an exemplary view illustrating states of legs during one step of the robot in accordance with an embodiment;

FIGS. 7(a) to 7(c) are exemplary views illustrating rapid walking of the robot in accordance with an embodiment;

FIG. 8 is a detailed block diagram of a target angle trajectory generation unit of the walking control apparatus of the robot in accordance with an embodiment;

FIG. 9 is a flow chart illustrating a walking control method of the robot in accordance with an embodiment;

FIGS. 10(a) to 13(b) are exemplary views illustrating reference pitch angle trajectories of a hip joint unit of the robot in accordance with an embodiment;

FIG. 14 is an exemplary view illustrating a reference pitch angle trajectory of an ankle joint unit of the robot in accordance with an embodiment; and

FIGS. 15(a) and 15(b) are exemplary views illustrating a target pitch angle trajectory and a target roll angle trajectory of the hip joint unit of the robot in accordance with an embodiment.

### DETAILED DESCRIPTION

Reference will now be made in detail to embodiments, examples of which are illustrated in the accompanying drawings, wherein like reference numerals refer to like elements throughout.

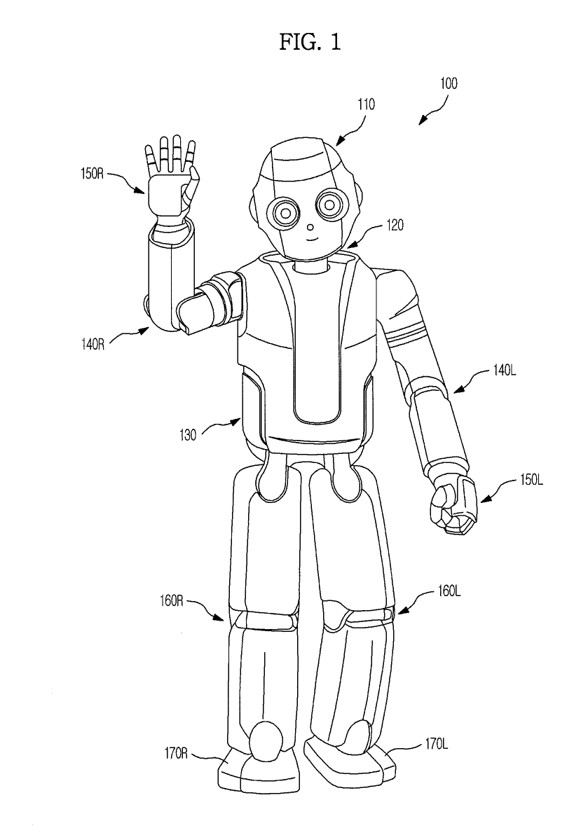

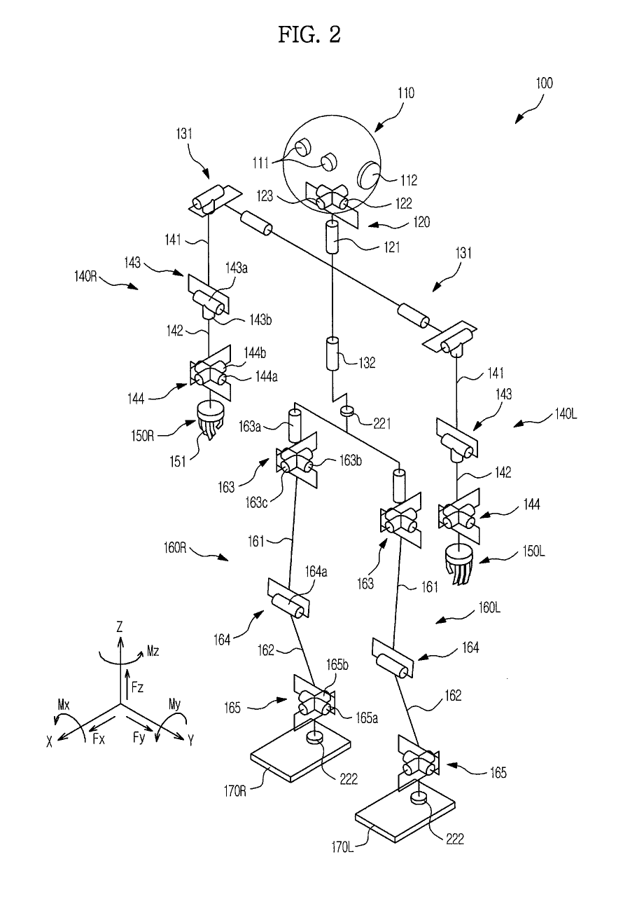

FIG. 1 is an exemplary view of a robot in accordance with an embodiment and FIG. 2 is an exemplary view illustrating structures of joints of the robot in accordance with an embodiment.

As shown in FIG. 1, a robot 100 in accordance with an embodiment includes an upper body including a head 110, a neck 120, a torso 130, arms 140R and 140L and hands 150R and 150L, and a lower body including a plurality of legs 160R and 160L and feet 170R and 170L.

In more detail, the upper body of the robot 100 includes the head 110, the torso 130 connected to the lower portion of the head 110 through the neck 120, the two arms 140R and 140L connected to both sides of the upper portion of the torso 130, and the hands 150R and 150L respectively connected to tips of the two arms 140R and 140L.

The lower body of the robot 100 includes two legs 160R and 160L connected to both sides of the lower portion of the torso 130 of the upper body, and the feet 170R and 170L respectively connected to tips of the two legs 160R and 160L.

Here, the head 110, the two arms 140R and 140L, the two hands 150R and 150L, the two legs 160R and 160L, and the two feet 170R and 170L respectively have designated degrees of freedom through joints.

Such upper and lower bodies of the robot 100 are protected by a cover.

Here, “R” and “L” respectively indicate the right and left sides of the robot 100.

With reference to FIG. 2, joints of the robot 100 will be described in more detail.

Cameras 111 to capture surrounding images and microphones 112 to detect a user's voice are installed on the head 110.

The neck 120 connects the head 110 and the torso 130. The neck 120 includes a neck joint unit.

The neck joint unit includes a rotary joint 121 in the yaw direction (rotated around the Z-axis), a rotary joint 122 in the pitch direction (rotated around the Y-axis), and a rotary joint 123 in the roll direction (rotated around the X-axis), and thus has 3 degrees of freedom. Here, the rotary joints 121, 122 and 123 of the neck joint unit are respectively connected to head rotating motors (not shown).

Shoulder joints units 131 to connect the two arms 140R and 140L to the torso 130 are respectively provided at both sides of the torso 130, and a rotary joint unit 132 in the yaw direction to allow a breast to rotate around a waist is provided between the breast and the waist.

Each of the two arms 140R and 140L includes an upper arm link 141, a lower arm link 142, an elbow joint unit 143, and a wrist joint unit 144.

Here, the upper arm links 141 of the two arms 140R and 140L are respectively connected to the torso 130 through shoulder joint units 131 and are respectively connected to the lower arm links 142 through the elbow joint units 143. The lower arm links 142 are connected to the hands 150R and 150L through the wrist joint units 144.

Each elbow joint unit 143 includes a rotary joint 143a in the pitch direction and a rotary joint 143b in the yaw direction, and thus has 2 degrees of freedom. Each wrist joint unit 144 include a rotary joint 144a in the pitch direction and a rotary joint 144b in the roll direction, and thus has 2 degrees of freedom.

Each hand 150R or 150L is provided with five fingers 151. A plurality of joints (not shown) driven by motors may be installed on the respective fingers 151. The fingers 151 perform various motions, such as gripping of an article or pointing in a specific direction, in connection with movement of the arms 140R and 140L.

Each of the two legs 160R and 160L of the robot 100 includes a thigh link 161, a calf link 162, a hip joint unit 163, a knee joint unit 164 and an ankle joint unit 165.

The thigh links 21 of the two legs 160 R and 160L are respectively connected to the torso 130 through the hip joint units 163 and are respectively connected to the calf links 162 through the knee joint units 164. The thigh links 162 are respectively connected to the feet 170R and 170L through the ankle joint units 165.

Each hip joint unit 163 includes a rotary joint 163a in the yaw direction (rotated around the Z-axis), a rotary joint 63b in the pitch direction (rotated around the Y-axis), and a rotary joint 163c in the roll direction (rotated around the X-axis), and thus has 3 degrees of freedom.

Each knee joint unit 164 includes a rotary joint 164a in the pitch direction, and thus has 1 degree of freedom. Each ankle joint unit 165 includes a rotary joint 165a in the pitch direction and a rotary joint 165b in the roll direction, and thus has 2 degrees of freedom.

Since 6 rotary joints of the three joint units 163, 164 and 165 are provided to each of the two legs 160R and 160L, a total of 12 rotary joints is provided to the two legs 160R and 160L.

Actuators, such as motors (not shown), are provided at the respective joints of the robot 100. Thereby, the respective joints perform proper rotating movements through rotation of the motors, thus achieving various motions.

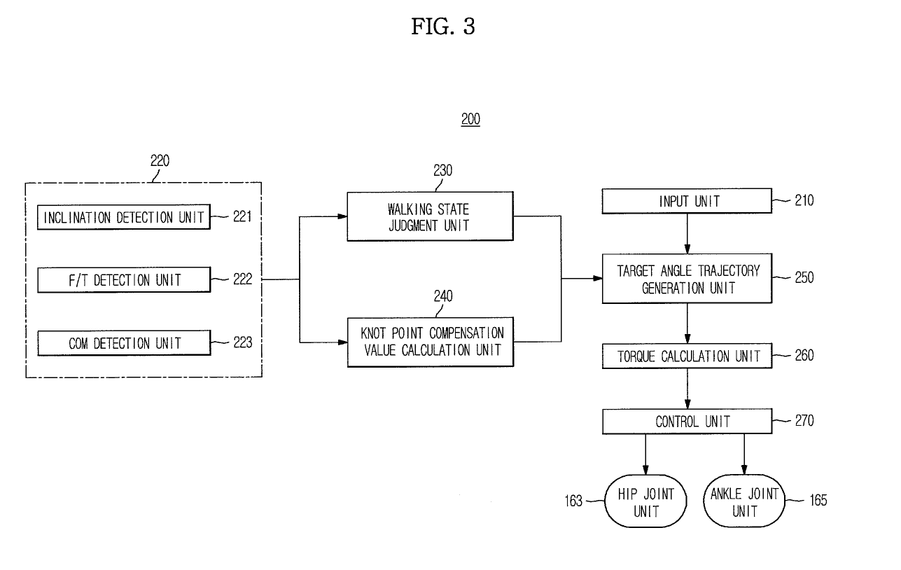

Therefore, when the robot 100 walks, the robot 100 may perform stable and natural walking while remaining balanced. This will be described in detail with reference to FIG. 3.

FIG. 3 is a control block diagram of a walking control apparatus 200 of the robot in accordance with an embodiment. The walking control apparatus 200 of the robot includes an input unit 210, a pose detection unit 220, a walking state judgment unit 230, a knot point compensation value calculation unit 240, a target angle trajectory generation unit 250, a torque calculation unit 260, and a control unit 270.

The input unit 210 serves to receive a walking command of the robot from a user and to receive a walking velocity of the robot. Here, the input unit 210 may function as a communication unit to receive a walking command and a walking velocity of the robot which are transmitted from the outside.

That is, the robot drives the plural motors (not shown) installed at the respective joint units 163 and 165 based on a user command received through the input unit 210 and a pose of the robot, thereby performing stable walking at a walking velocity corresponding to the user command.

Here, the walking velocity is adjusted by at least one of a step length and a step cycle of each leg. Further, walking velocities corresponding to step lengths, walking velocities corresponding to step cycles and walking velocities corresponding to the relation between the step lengths and the step cycles are stored in advance.

The pose detection unit 220 detects a pose of the robot and transmits detected pose data to the walking state judgment unit 230 and the knot point compensation value calculation unit 240. Here, the pose data of the robot means landing data of the robot, data regarding a support leg and a swing leg corresponding to landing, and center of mass (COM) data of the robot.

The pose detection unit 220 includes an inclination detection unit 221 to detect an inclination of the torso of the robot, a force/torque (F/T) detection unit 222 to detect whether or not the robot lands and a support leg and a swing leg corresponding to whether or not the robot lands, and a COM detection unit 223 to detect a variation of the COM of the robot.

The inclination detection unit 221 is provided on the torso 130 and detects an inclination of the torso with respect to the vertical line, i.e., rotating angles of three axes including pitch, roll and yaw axes, and angular velocities thereof. The inclination detection unit 221 may employ an inertial measurement unit (IMU) to measure inertia.

The F/T detection unit 222 includes multi-axis F/T sensors respectively installed between the legs 160R and 160R and the feet 170R and 170L, and detects load applied to the feet 170R and 170L.

The F/T detection unit 222 measure three directional components Fx, Fy, and Fz of force and three directional components Mx, My, and Mz of moment transmitted to the feet 112L and 112R, and transmits the components to the walking state judgment unit 230.

The COM detection unit 223 detects the COM of the robot based on torso inclination data detected by the inclination detection unit 221 and rotating angles of the respective joint units 131, 143, 144, 163, 164 and 165 corresponding to a current pose of the robot, calculates a variation of the detected COM, and transmits the calculated variation of the COM to the knot point compensation value calculation unit 240.

Here, the rotating angles of the respective joint units 131, 143, 144, 163, 164 and 165 are calculated through RPMs of the plural motors (not shown) provided at the respective joint units 131, 143, 144, 163, 164 and 165. The RPMs of the respective motors are detected by encoders (not shown) connected to the respective motors.

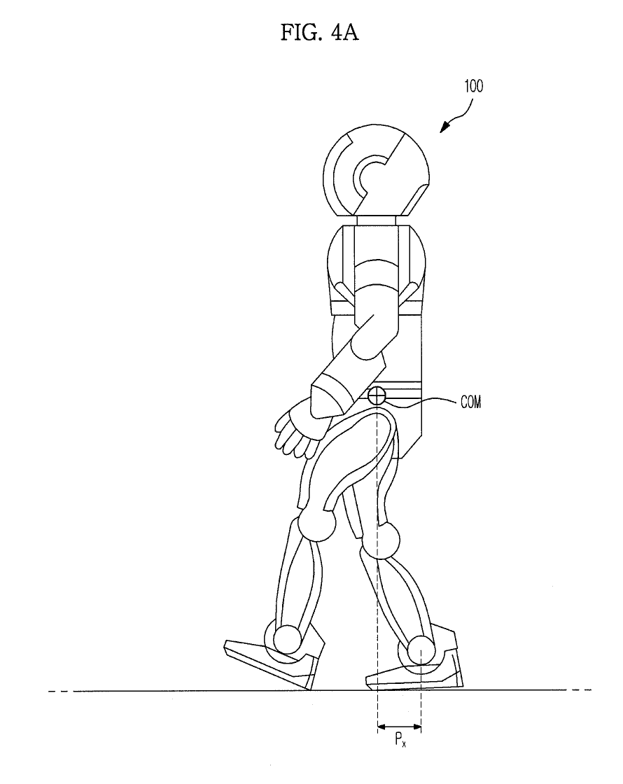

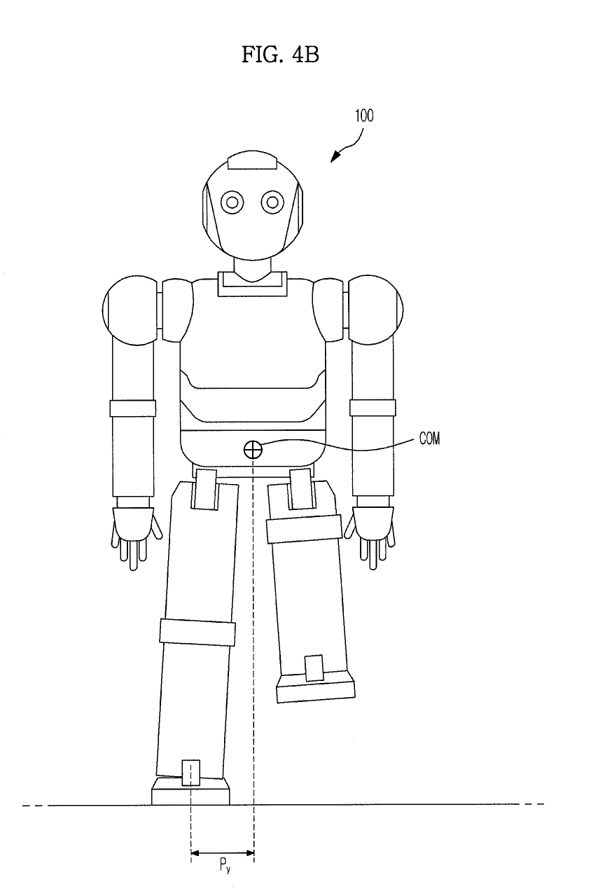

As shown in FIGS. 4A and 4B, the COM detection unit 223 calculates a variation Px of the COM in the X-axis direction corresponding to a walking direction of the robot and a variation Py of the COM in the Y-axis direction corresponding to a lateral direction of the robot.

Here, variations Px and Py of the COM are distances between a position of the vertical line of the COM of the robot and a position of an ankle of a foot contacting the ground in the X-axis direction and in the Y-axis direction. That is, the robot keeps its balance only if the vertical line of the COM of the robot coincides with the position of the ankle of the support leg during walking of the robot, and for this purpose, the distances between the position of the vertical line of the COM of the robot and the position of the ankle of the support leg need to be detected.

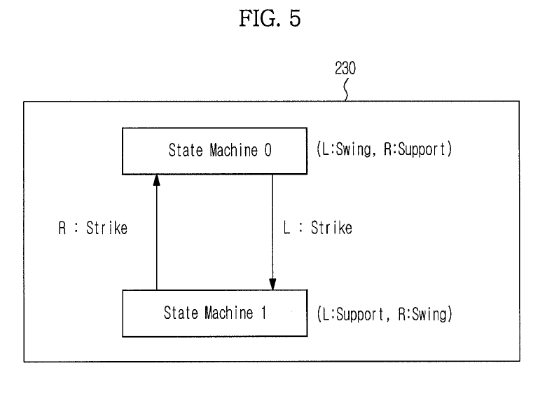

The walking state judgment unit 230 judges whether or not the robot lands based on loads applied to the respective feet detected by the F/T detection unit 222 of the pose detection unit 220, judges one leg, load of which is detected, to be in a support state, and judges the other leg, load of which is not detected, to be in a swing state. The walking state judgment unit 230 will be described in more detail with reference to FIG. 5.

FIG. 5 is a view illustrating a detailed configuration of the walking state judgment unit 230 of the walking control apparatus of the robot in accordance with an embodiment.

The walking state judgment unit 230 judges the robot to be in a landing state, if load is applied to at least one of the two feet.

The walking state judgment unit 230 judges to which leg out of the two legs load is applied. Upon judging that load is applied to the foot of the right leg, the walking state judgment unit 230 judges the right leg to be in the support state and the left leg to be in the swing state, and recognizes this situation to be a ‘state machine 0’.

Further, upon judging that load is applied to the foot of the left leg, the walking state judgment unit 230 judges the left leg to be in the support state and the right leg to be in the swing state, recognizes this situation to be a ‘state machine 1’, and transmits recognized data to the target angle trajectory generation unit 250.

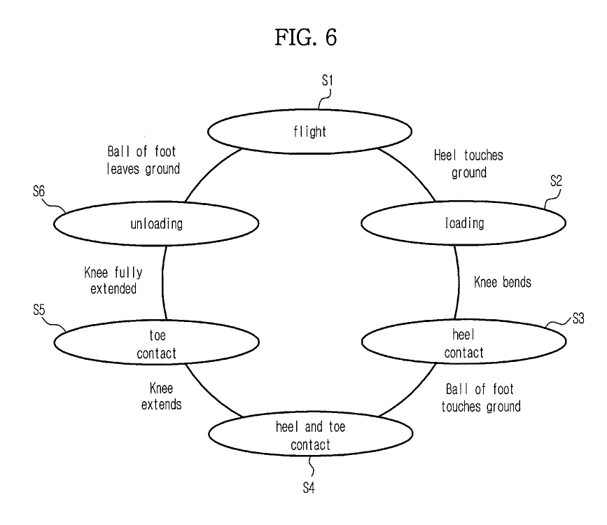

Such a walking state judgment unit 230 stores walking state data of the two legs based on a finite state machine (FSM). Here, the FSM sequentially represents restricted state changes of the two legs. This will be described with reference to FIG. 6.

FIG. 6 is an exemplary view illustrating one step of the robot in accordance with an embodiment during walking. That is, FIG. 6 illustrates states of one leg of the robot in one step and control actions of the respective states, while the robot in accordance with an embodiment walks based on the FSM.

A first state (flight state) S1 corresponds to a pose of swinging one leg, a second state (loading state) S2 corresponds to a pose of loading the foot of the leg on the ground, a third state (heel contact state) S3 corresponds to a pose of bringing the heel of the foot into contact with the ground, a fourth state (heel and toe contact state) S4 corresponds to a pose of bringing both the heel and the toe of the foot into contact with the ground, a fifth state (toe contact state) S5 corresponds to a pose of bringing the toe of the foot into contact with the ground, and a sixth state (unloading state) S6 corresponds to a pose of unloading the foot from the ground.

In order to transition from one state to another state, a control action to achieve such transition is required.

Here, if the first state S1 transitions to the second state S2 (S1→S2), a control action in which the heel of the foot touches the ground is required. If the second state S2 transitions to the third state S3 (S2→S3), a control action in which the knee of the foot touching the ground bends is required. If the third state S3 transitions to the fourth state S4 (S3→S4), a control action in which the ball of the foot touches the ground is required. If the fourth state S4 transitions to the fifth state S5 (S4→S5), a control action in which the knee of the foot touching the ground extends is required. If the fifth state S5 transitions to the sixth state S6 (S4→S5), a control action in which the knee of the foot touching the ground fully extends is required. If the sixth state S6 transitions to the first state S1 (S6→S1), a control action in which the ball of the foot leaves the ground is required.

The knot point compensation value calculation unit 240 calculates a reference pitch knot point compensation value ΔP and a reference roll knot point compensation value ΔR of the hip joint units 163 to perform the next step based on the variations Px and Py of the COM detected by the COM detection unit 223.

In more detail, the knot point compensation value calculation unit 240 calculates the pitch knot point compensation value ΔP of the hip joint units 163 in the next step by comparing the actual variation Px of the COM in the X-axis direction with a reference variation Pr1 of the COM in the X-axis direction.

Further, the knot point compensation value calculation unit 240 calculates the roll knot point compensation value ΔR of the hip joint units 163 in the next step by comparing the actual variation Py of the COM in the Y-axis direction with a reference variation Pr2 of the COM in the Y-axis direction.

Here, the pitch knot point compensation value ΔP and the roll knot point compensation value ΔR of the hip joint units 163 are calculated using Proportional-Derivative (PD) control. Calculation of the pitch knot point compensation value ΔP and the roll knot point compensation value ΔR using PD control is carried out by the following Equation 1 and Equation 2.

ΔP=Kp1(Px−Pr1)+Kd1(Px′−Pr1′) (Equation 1)

ΔR=Kp2(Py−Pr2)+Kd2(Py′−Pr2′) (Equation 2)

Here, Kp1 and Kp2 are p gains of PD control and Kd1 and Kd2 are d gains of PD control. These gains of PD control are values set through repeated experimentation so as to perform optimized and stable walking, and position data of reference COM are set in advance corresponding to walking states of the robot.

Further, Px is an actual variation of the COM in the X-axis direction corresponding to a walking direction of the robot and Py is an actual variation of the COM in the Y-axis direction corresponding to a lateral direction of the robot.

That is, Px is an actual distance between the position of the vertical line of the COM of the robot and the position of the ankle of the support leg in the X-axis direction, Px′ is an actual velocity obtained by taking the derivative of the actual distance Px, Py is an actual distance between the position of the vertical line of the COM of the robot and the position of the ankle of the support leg in the Y-axis direction, and Py′ is an actual velocity obtained by taking the derivative of the actual distance Py. Here, the actual velocities Px′ and Py′ may be directly detected.

Further, Pr1 is a reference variation of the COM in the X-axis direction corresponding to the walking direction of the robot and Pr2 is a reference variation of the COM in the Y-axis direction corresponding to the lateral direction of the robot. That is, Pr1 is a reference distance between the position of the vertical line of the COM of the robot and the position of the ankle of the support leg in the X-axis direction, Pr1′ is a reference velocity obtained by taking the derivative of the reference distance Pr1, Pr2 is a reference distance between the position of the vertical line of the COM of the robot and the position of the ankle of the support leg in the Y-axis direction, and Pr2′ is a reference velocity obtained by taking the derivative of the reference distance Pr2.

The target angle trajectory generation unit 250 calculates target pitch angle trajectories of the joint units 163 and 165 of the respective legs in the next step based on the state data of the respective legs in the current step judged by the walking state judgment unit 230, the walking velocity received through the input unit 210 and the pitch knot point compensation value of the hip joint units 163 calculated by the knot point compensation value calculation unit 240.

In more detail, the target angle trajectory generation unit 250 determines a pitch rotating angle of the hip joint unit 163 to perform the next step and a step time for which the next step is performed based on the walking velocity received from the user, determines reference pitch knot points of the hip joint unit 163 based on the pitch rotating angle of the hip joint unit 163 and the step time, and connects the reference pitch knot points of the hip joint unit 163 so as to generate a reference angle trajectory.

Here, the pitch rotating angle of the hip joint unit 163 may be an angle of the hip joint unit 163 when the toe of the foot contacts the ground or an angle of the hip joint unit 163 when the heel of the foot contacts the ground. The target angle trajectory generation unit 250 determines the angle of the hip joint unit 163 when the toe of the foot contacts the ground to be a first reference pitch knot point (K=1) and determines the angle of the hip joint unit 163 when the heel of the foot contacts the ground to be a second reference pitch knot point (K=2).

The first reference pitch knot point (K=1) and the second reference pitch knot point (K=2) of the hip joint unit 163 are defined by the following Equation 3 and Equation 4.

K=1: HipPitchBend+PitchSweep (Equation 3)

K=2: HipPitchBend−PitchSweep (Equation 4)

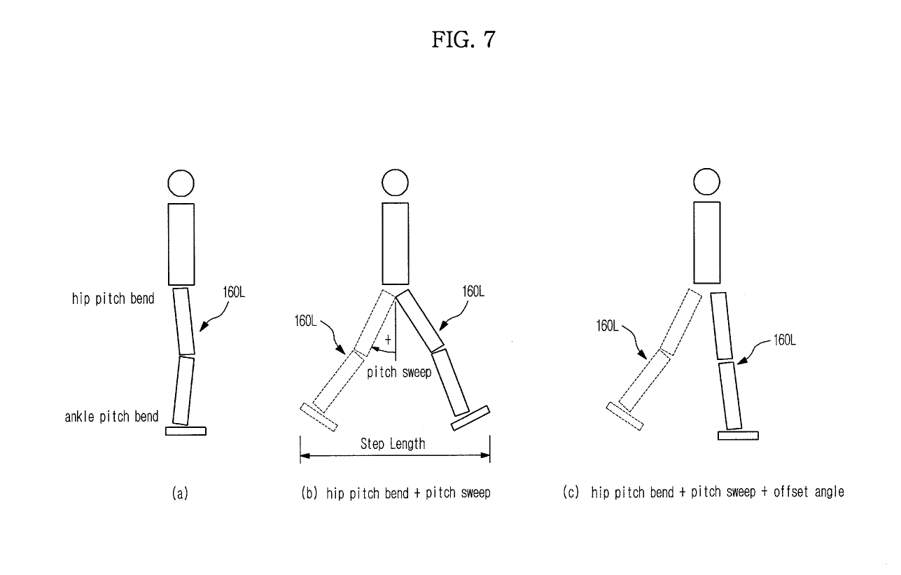

Here, HipPitchBend is an angle of the hip joint unit 163 when the robot stands erect, as shown in FIG. 7(a), and PitchSweep includes a first angle at which the leg swings backwards with respect to the vertical line to the ground when the foot of the swing leg leaves the ground and a second angle at which the leg swings forwards with respect to the vertical line to the ground when the foot of the swing leg contacts the ground, as shown in FIG. 7(b).

The first angle and the second angle have the same value. However, the first angle has a positive value but the second angle has a negative value according to rotating direction.

Here, an amplitude between the first reference pitch knot point and the second reference pitch knot point of the hip joint unit 163 corresponds to a step length of one step, and a time from the first reference pitch knot point to the second reference pitch knot point is a step time during which one step is performed. The step time is proportional to the step cycle.

The walking velocity may be changed by adjusting the step length and the step time.

Further, step lengths and step times corresponding to walking velocities and angles of the respective hip joint units 163 according to step lengths are set in advance through experimentation.

If the amplitude of the hip joint unit 163 of the robot is excessively increased, the COM of the robot is located at an excessively backward position when the heel of the foot contacts the ground and thus the robot may fall backwards.

Therefore, the target angle trajectory generation unit 250 respectively reflects an offset angle in the first angle +PitchSweep and the second angle −PitchSweep of the swing leg in order to achieve stable walking of the robot, thereby respectively compensating for the first reference pitch knot point (K=1) and the second reference pitch knot point (K=2).

Such compensated first reference pitch knot point (K=1) and second reference pitch knot point (K=2) of the hip joint unit 163 are defined by the following Equation 5 and Equation 6.

K=1: HipPitchBend+PitchSweep+OffsetAngle (Equation 5)

K=2: HipPitchBend−PitchSweep+OffsetAngle (Equation 6)

Such an offset angle is defined by the following Equation 7.

OffsetAngle=Kp×PitchSweep+Kd×vCOM(midstance) (Equation 7)

Here, COM(midstance) is a distance between the center of the support leg and the COM of the robot, vCOM(midstance) is a velocity at COM(midstance), Kp is a P gain of Proportional control, and Kd is a D gain of Derivative control. Kp and Kd are values set through repeated experimentation.

Further, OffsetAngle is an angle selected from angles obtained in advance through repeated experimentation according to Pitchsweep, or an angle calculated based on PitchSweep detected in the current step.

As described above, when the offset angle is reflected in the first angle +PitchSweep and the second angle −PitchSweep, the robot switches walking from a forward and backward symmetrical walking manner with respect to the vertical line, as shown in FIG. 7(b), to a forward and backward nonsymmetrical walking manner, as shown in FIG. 7(c).

Thereby, the distance between the COM of the robot and the leg, the heel of the foot of which contacts the ground is reduced, and thus the robot achieves stable walking without falling backwards.

If only the amplitude of the hip joint unit 163 is increased in order to increase the walking velocity, an amount of impact absorbed by the ankle joint unit 165 when the heel of the foot contacts the ground is increased. Therefore, the target angle trajectory generation unit 250 determines a first reference pitch knot point (K=1) and a second reference pitch knot point (K=2) of the ankle joint unit 165 to uniformize the amount of impact absorbed by the ankle joint unit 165, and connects the first and second reference pitch knot points so as to generate a reference angle trajectory of the ankle joint unit 165.

The first reference pitch knot point (K=1) and the second reference pitch knot point (K=2) of the ankle joint unit 165 are defined by the following Equation 8 and Equation 9.

K=1: AnklePitchBend−PitchSweep+OffsetAngle (Equation 8)

K=2: AnklePitchBend+PitchSweep+OffsetAngle (Equation 9)

Here, AnklePitchBend is an angle of the ankle joint unit 165 when the robot stands erect, as shown in FIG. 7(a).

Further, the first reference pitch knot point (K=1) of the ankle joint unit 165 is an angle of the ankle joint unit 165 when the toe of the foot contacts the ground, and the second reference pitch knot point (K=2) of the ankle joint unit 165 is an angle of the ankle joint unit 165 when the heel of the foot contacts the ground.

The target angle trajectory generation unit 250 generates target pitch knot points of the hip joint unit 163 by applying the pitch knot point compensation value to the reference pitch knot points of the hip joint unit 163 to perform the next step, connects the target pitch knot points so as to generate a target pitch angle trajectory, and transmits the generated target pitch angle trajectory to the torque calculation unit 260.

The target angle trajectory generation unit 250 determines roll angles of the hip joint unit 163 to perform the next step based on the state data of the respective legs in the current step judged by the walking state judgment unit 230, determines the determined roll angles of the hip joint unit 163 to be reference roll knot points, generates target roll knot points by compensating for the determined reference roll knot points with a roll knot point compensation value of the hip joint unit 163 calculated by the knot point compensation value calculation unit 240, connects the target roll knot points so as to generate a target roll angle trajectory, and transmits the generated target roll angle trajectory to the torque calculation unit 260.

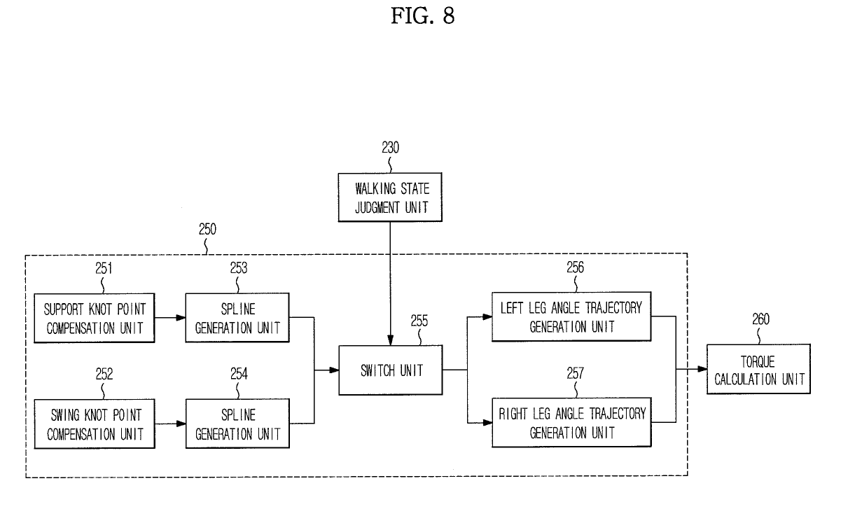

This will be described in more detail with reference to FIG. 8.

FIG. 8 is a detailed block diagram of the target angle trajectory generation unit 250 of the walking control apparatus of the robot in accordance with an embodiment. The target angle trajectory generation unit 250 includes a support knot point compensation unit 251, a swing knot point compensation unit 252, spline generation units 253 and 254, a switch unit 255, a left leg angle trajectory generation unit 256, and a right leg angle trajectory generation unit 257.

As shown in FIG. 8, the support knot point compensation unit 251 generates target pitch knot points of the hip joint unit 163 of the support leg by compensating for reference pitch knot points of the hip joint unit 163 of a leg, which will support the ground in the next step, with the pitch knot point compensation value ΔP in the current step, and generates target roll knot points of the hip joint unit 163 of the support leg by compensating for reference roll knot points of the hip joint unit 163 of the leg, which will support the ground in the next step, with the roll knot point compensation value ΔR in the current step.

The swing knot point compensation unit 252 generates target pitch knot points of the hip joint unit 163 of the swing leg by compensating for reference pitch knot points of the hip joint unit 163 of a leg, which will swing in the next step, with the pitch knot point compensation value ΔP in the current step, and generates target roll knot points of the hip joint unit 163 of the swing leg by compensating for reference roll knot points of the hip joint unit 163 of the leg, which will swing in the next step, with the roll knot point compensation value ΔR in the current step.

Further, the swing knot point compensation unit 252 generates target pitch knot points of the ankle joint unit 165 of the swing leg by compensating for reference pitch knot points of the ankle joint unit 165 of the leg, which will swing in the next step, with the pitch knot point compensation value ΔP in the current step.

The spline generation unit 253 respectively connects the target pitch knot points and the target roll knot points of the hip joint unit 163 of the support leg by splines, thereby generating a target pitch angle trajectory and a target roll angle trajectory of the hip joint unit 163 of the support leg.

The spline generation unit 254 respectively connects the target pitch knot points and the target roll knot points of the hip joint unit 163 of the swing leg by splines, thereby generating a target pitch angle trajectory and a target roll angle trajectory of the hip joint unit 163 of the swing leg.

The spline generation unit 254 connects the target pitch knot points of the ankle joint unit 165 of the swing leg by a spline, thereby generating a target pitch angle trajectory of the ankle joint unit 165 of the swing leg.

The switch unit 255 judges the support and swing legs corresponding to walking state data (0 or 1) of the respective legs transmitted from the walking state judgment unit 230, and as a result of judgment, transmits support target pitch angle trajectory data and support target roll angle trajectory data of the hip joint unit 163 to the support leg and swing target pitch angle trajectory data and swing target roll angle trajectory data of the hip joint unit 163 and target pitch angle trajectory data of the ankle joint unit 165 to the swing leg.

The switch unit 255 performs switching between the support state and the swing state of each foot based on a landing signal detected by the F/T detection unit 222 when the two feet respectively land on the ground.

The left leg angle trajectory generation unit 256 generates a target pitch angle trajectory and a target roll angle trajectory, which the hip joint unit 163 of the left leg need to track, according to data transmitted from the switch unit 255 and transmits the generated trajectories to the torque calculation unit 260, and generates a target pitch angle trajectory, which the ankle joint unit 165 of the left leg needs to track, according to the data transmitted from the switch unit 255 and transmits the generated trajectory to the torque calculation unit 260.

The right leg angle trajectory generation unit 257 generates a target pitch angle trajectory and a target roll angle trajectory, which the hip joint unit 163 of the right leg need to track, according to the data transmitted from the switch unit 26 and transmits the generated trajectories to the torque calculation unit 260, and generates a target pitch angle trajectory, which the ankle joint unit 165 of the right leg needs to track, according to the data transmitted from the switch unit 255 and transmits the generated trajectory to the torque calculation unit 260.

The torque calculation unit 260 respectively calculates torques to track the target pitch angle trajectories and the target roll angle trajectories of the hip joint units 163 and the target pitch angle trajectories of the ankle joint units 165 of the respective legs transmitted from the target angle trajectory generation unit 250.

Such a torque calculation unit 260 calculates torques which will be applied to the respective joints of the respective joint units 163 and 165 using PD control, and a torque is calculated by the following Equation 10.

T=kp3(θd−θc)+kd3(θd′−θc′)

Here, kp3 is a P gain of PD control, kd3 is a D gain of PD control, θd is a target angle of the hip joint unit, and θc is a current angle of the hip joint unit. P and D gains are values set through repeated experimentation so as to perform stable walking.

Further, torque is rotary force of a motor (not shown) to track the target angle.

The servo control unit 360 controls Pulse Width Modulations (PWMs) according to the calculated torques in order to generate the torques calculated by the torque calculation unit 260, and then outputs the torques to the motors (not shown) provided at the hip joint units 163 and the ankle joint units 165.

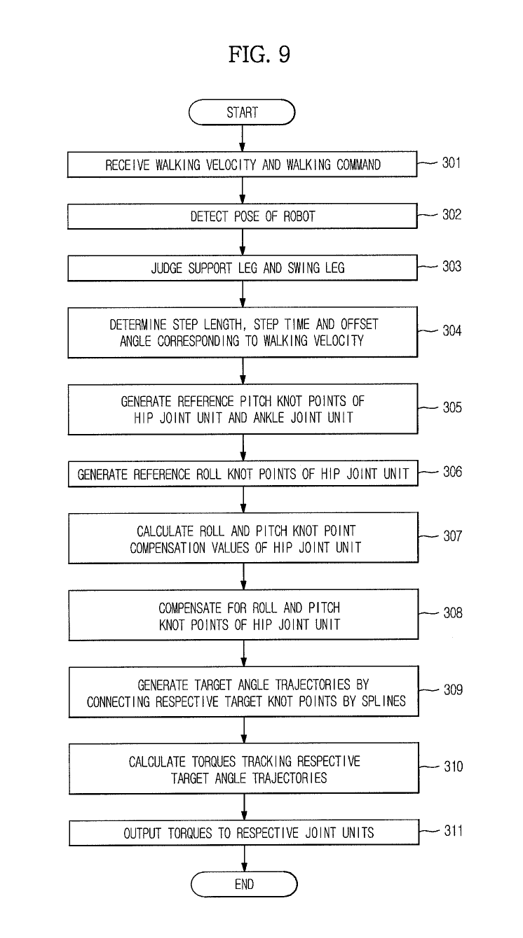

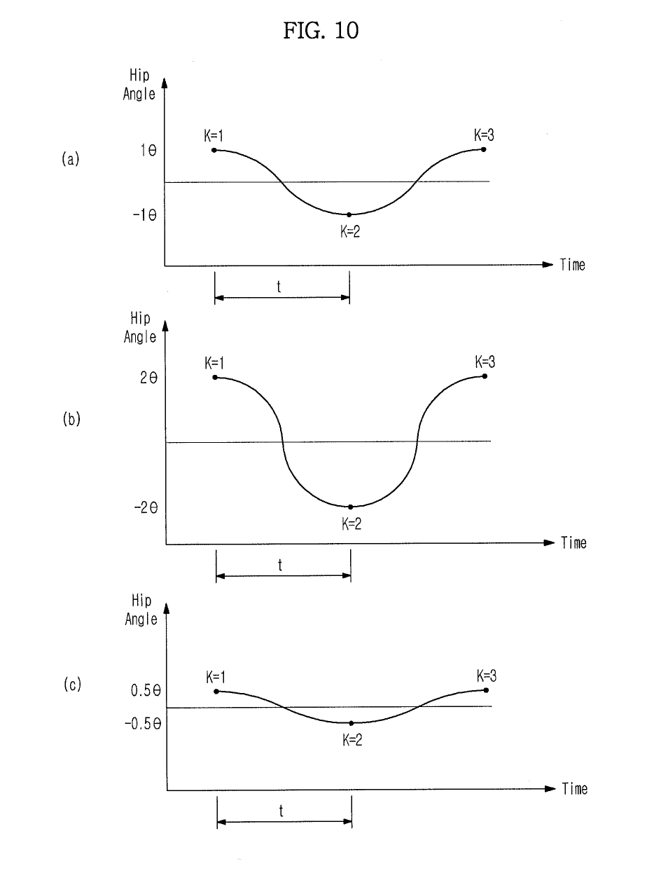

FIG. 9 is a flow chart illustrating a walking control method of the robot in accordance with an embodiment. Hereinafter, the walking control method of FIG. 9 will be described with reference to FIGS. 10(a) to 15(b).

The robot 100 judges whether or not a walking velocity of the robot 100 is received through the input unit 210 and whether or not a walking command is received (Operation 301). Upon judging that the walking velocity and the walking command are received, the robot 100 detects a pose of the robot 100 (operation 302).

During detection of the pose of the robot 100, the robot 100 judges loads applied to the respective ankles and judges the COM of the robot 100.

The robot 100 judges which leg is a support leg and which leg is a swing leg based on the loads applied to the respective ankles as a result of judgment of the loads (Operation 303).

The robot 100 generates reference pitch knot points of the hip joint unit 163 and reference pitch knot points of the ankle joint unit 165 of the leg, which will swing in the next step, based on a result of judgment.

In more detail, the robot 100 determines a step length of the next step and a step time for which the next step is performed based on the walking velocity received from a user. Here, the step length corresponds to a pitch rotating angle of the hip joint unit 163. That is, the robot 100 determines the pitch rotating angle of the hip joint unit 163 based on the walking velocity.

If the step length is excessively increased, the COM of the robot 100 is located at an excessively backward position when the heel of the foot contacts the ground and thus the robot 100 may fall backwards. Therefore, in order to prevent the robot 100 from falling, the robot 100 determines an offset angle based on the pitch rotating angle of the hip joint unit 163 (Operation 304).

Thereafter, the robot 100 generates reference pitch knot points of the hip joint unit 163 based on the pitch rotating angle, the step time, and the offset angle of the hip joint unit 163.

Here, the pitch rotating angle of the hip joint unit 163 may be an angle of the hip joint unit 163 when the toe of the foot contacts the ground or an angle of the hip joint unit 163 when the heel of the foot contacts the ground. The target angle trajectory generation unit 250 determines the angle of the hip joint unit 163 when the toe of the foot contacts the ground to be a first reference pitch knot point (K=1) and determines the angle of the hip joint unit 163 when the heel of the foot contacts the ground to be a second reference pitch knot point (K=2).

That is, the first reference pitch knot point (K=1) and the second reference pitch knot point (K=2) of the hip joint unit 163 are defined by the following Equations.

K=1: HipPitchBend+PitchSweep+OffsetAngle

K=2: HipPitchBend−PitchSweep+OffsetAngle

Here, HipPitchBend is an angle of the hip joint unit 163 when the robot stands erect, and PitchSweep is an angle at which the leg swings backwards or forwards with respect to the vertical line to the ground.

The offset angle is defined by the following Equation.

OffsetAngle=Kp×PitchSweep+Kd×vCOM(midstance)

Here, COM(midstance) is a distance between the center of the support leg and the COM of the robot, vCOM(midstance) is a velocity at COM(midstance), Kp is a P gain of Proportional control, and Kd is a D gain of Derivative control.

Further, if only the amplitude of the hip joint unit 163 is increased in order to increase the walking velocity of the robot 100, an amount of impact absorbed by the ankle joint unit 165 when the heel of the foot contacts the ground is increased. Therefore, in order to uniformize the amount of impact absorbed by the ankle joint unit 165, a first reference pitch knot point (K=1) and a second reference pitch knot points (K=2) of the ankle joint unit 165 are generated (Operation 305).

The first reference pitch knot point (K=1) of the ankle joint unit 165 is an angle of the ankle joint unit 165 when the toe of the foot contacts the ground and the second reference pitch knot point (K=2) of the ankle joint unit 165 is an angle of the ankle joint unit 165 when the heel of the foot contacts the ground.

The first reference pitch knot point (K=1) and the second reference pitch knot point (K=2) of the ankle joint unit 165 are defined by the following Equations.

K=1: AnklePitchBend−PitchSweep+OffsetAngle

K=2: AnklePitchBend+PitchSweep+OffsetAngle

Here, AnklePitchBend is an angle of the ankle joint unit 165 when the robot stands erect.

The robot 100 generates reference pitch knot points and reference roll knot points of the hip joint unit 163 of a leg, which will support the ground in the next step, and reference roll knot points of the hip joint unit 163 of a leg which, will swing in the nest step, based on a result of judgment of the support leg and the swing leg (Operation 306).

Thereafter, the robot 100 calculates a roll knot point compensation value and a pitch knot point compensation value by judging a variation of the COM of the robot 100 and comparing the actual variation of the COM of the robot 100 in the current step with a reference variation of the COM of the robot 100 in the current step (Operation 307).

In more detail, the robot 100 calculates the pitch knot point compensation value ΔP of the hip joint unit 163 by comparing the actual variation Px of the COM in the X-axis direction with a reference variation Pr1 of the COM in the X-axis direction, and calculates the roll knot point compensation value ΔR of the hip joint unit 163 by comparing the actual variation Py of the COM in the Y-axis direction with a reference variation Pr2 of the COM in the Y-axis direction.

The robot 100 generates target pitch knot points of the hip joint unit 163 of the support leg by compensating for reference pitch knot points of the hip joint unit of a leg, which will support the ground in the next step, with the pitch knot point compensation value ΔP in the current step, and generates target roll knot points of the hip joint unit 163 of the support leg by compensating for reference roll knot points of the hip joint unit of the leg, which will support the ground the next step, with the roll knot point compensation value ΔR in the current step (Operation 308).

The robot 100 generates target pitch knot points of the hip joint unit 163 of the swing leg by compensating for reference pitch knot points of the hip joint unit 163 of a leg, which will swing in the next step, with the pitch knot point compensation value ΔP in the current step, and generates target roll knot points of the hip joint unit 163 of the swing leg by compensating for reference roll knot points of the hip joint unit 163 of the leg, which will swing in the next step, with the roll knot point compensation value ΔR in the current step (Operation 308).

Further, the robot 100 generates target pitch knot points of the ankle joint unit 165 of the swing leg by compensating for reference pitch knot points of the ankle joint unit 165 of the leg, which will swing in the next step, with the pitch knot point compensation value ΔP in the current step.

Thereafter, the robot 100 respectively connects the target pitch knot points and the target roll knot points of the hip joint unit 163 of the support leg by splines, thereby generating a target pitch angle trajectory and a target roll angle trajectory of the hip joint unit 163 of the support leg (Operation 309).

The robot 100 respectively connects the target pitch knot points and the target roll knot points of the hip joint unit 163 of the swing leg by splines, thereby generating a target pitch angle trajectory and a target roll angle trajectory of the hip joint unit 163 of the swing leg.

The robot 100 connects the target pitch knot points of the ankle joint unit 165 of the swing leg by a spline, thereby generating a target pitch angle trajectory of the ankle joint unit 165 of the swing leg.

Thereafter, the robot 100 respectively calculates torques to track the target pitch angles and the target roll angles of the hip joint units 163 and the target pitch angles of the ankle joint units 165 of the respective legs (Operation 310).

Thereafter, the robot 100 controls PWMs corresponding to the calculated torques, and then outputs the torques to the motors (not shown) provided at the hip joint units 163 and the ankle joint units 165, thereby rotating the motors.

The walking velocity of the robot 100 may be changed by adjusting at least one of the step length and the step time, as described above. This will be described with reference to FIGS. 10(a) to 13(b).

FIGS. 10(a) to 13(b) are exemplary views illustrating reference pitch angle trajectories of the hip joint unit if the offset angle is 0.

FIGS. 10(a), 10(b) and 10(c) illustrate reference pitch angle trajectories having different amplitudes under the condition that the offset angle is 0 and a step time t of one step is equal. The amplitude of FIG. 10(a) is 2θ, the amplitude of FIG. 10(b) is 4θ, and the amplitude of FIG. 10(c) is 1θ.

Here, the amplitude corresponds to the step length of one step during walking of the robot. Assuming that the amplitude is 2θ when the robot walks at a reference walking velocity, FIG. 10(a) illustrates the reference pitch angle trajectory of the hip joint unit 163 when the robot walks at the reference walking velocity, FIG. 10(b) illustrates the reference pitch angle trajectory of the hip joint unit 163 when the robot walks at a walking velocity higher than the reference walking velocity, and FIG. 10(c) illustrates the reference pitch angle trajectory of the hip joint unit 163 when the robot walks at a walking velocity lower than the reference walking velocity.

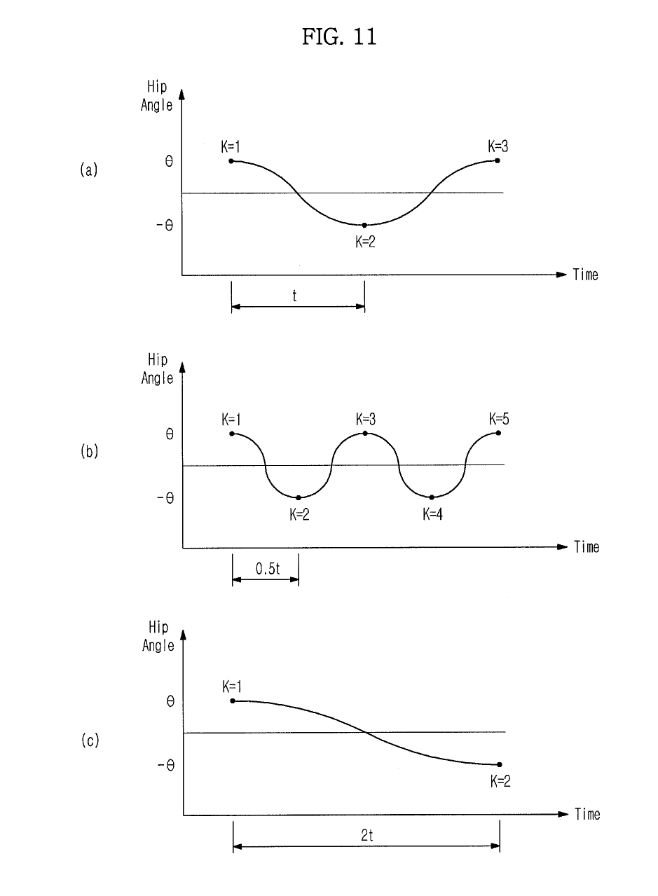

FIGS. 11(a), 11(b) and 11(c) illustrate reference pitch angle trajectories having different step times under the condition that the offset angle is 0 and an amplitude (step length) 2θ of one step is equal. The step time of FIG. 11(a) is t, the step time of FIG. 11(b) is 0.5t, and the step time of FIG. 11(c) is 2t.

Assuming that the step time is t when the robot walks at a reference walking velocity, FIG. 11(a) illustrates the reference pitch angle trajectory of the hip joint unit 163 when the robot walks at the reference walking velocity, FIG. 11(b) illustrates the reference pitch angle trajectory of the hip joint unit 163 when the robot walks at a walking velocity higher than the reference walking velocity, and FIG. 11(c) illustrates the reference pitch angle trajectory of the hip joint unit 163 when the robot walks at a walking velocity lower than the reference walking velocity.

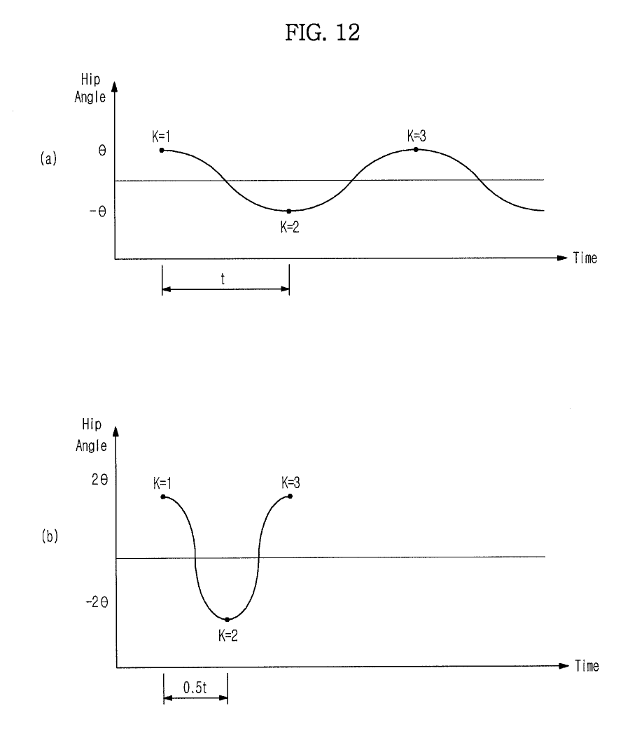

FIGS. 12(a) and 12(b) illustrate reference pitch angle trajectories having different amplitudes and step times under the condition that the offset angle is 0. In FIG. 12(a), the amplitude is 2θ and the step time is t, and in FIG. 12(b), the amplitude is 4θ and the step time is 0.5t.

Assuming that the amplitude is 2θ and the step time is t when the robot walks at a reference walking velocity, FIG. 12(a) illustrates the reference pitch angle trajectory of the hip joint unit 163 when the robot walks at the reference walking velocity and FIG. 12(b) illustrates the reference pitch angle trajectory of the hip joint unit 163 when the robot walks at a walking velocity much higher than the reference walking velocity.

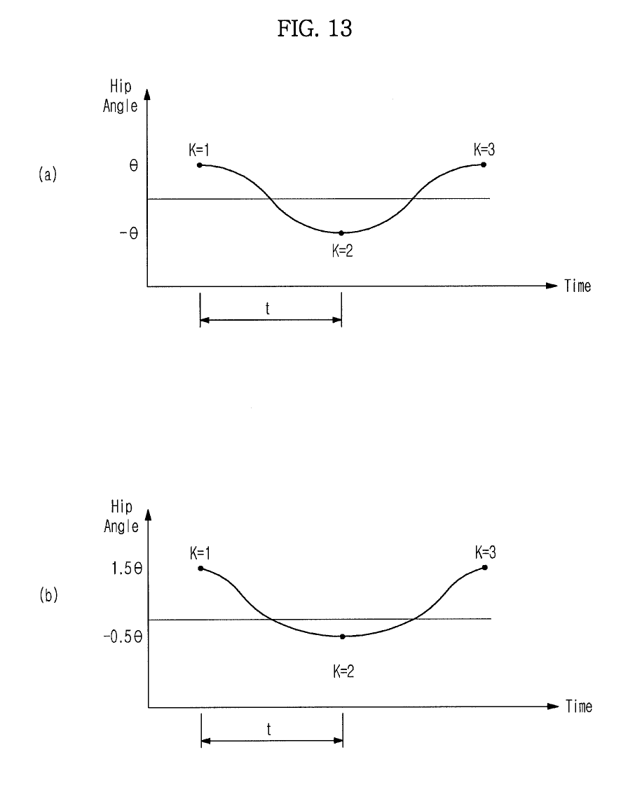

FIGS. 13(a) and 13(b) are exemplary views illustrating reference pitch angle trajectories of the hip joint unit according to offset angles.

FIGS. 13(a) and 13(b) illustrate reference pitch angle trajectories having a step length, i.e., an amplitude, of 2θ and a step time of t. FIG. 13(a) illustrates the reference pitch angle trajectory of the hip joint unit set so that the swing leg symmetrically moves forwards and backwards when the offset angle is 0, and FIG. 13(b) is the reference pitch angle trajectory of the hip joint unit set so that the swing leg nonsymmetrically moves forwards and backwards when the offset angle is 0.5θ.

As described above, the walking velocity of the robot may be changed by adjusting a step length of one step by adjusting an amplitude of the reference pitch angle trajectory or by adjusting a step time of one step by adjusting a cycle of the reference pitch angle trajectory.

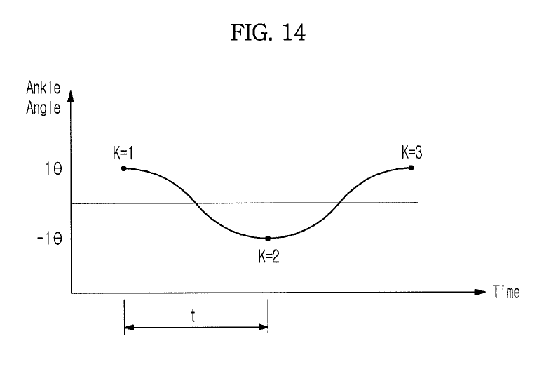

FIG. 14 illustrates a reference pitch angle trajectory of the ankle joint unit under the condition that the amplitude is 20 and the step time is t.

In more detail, FIG. 14 illustrates the reference pitch angle trajectory of the ankle joint unit obtained by generating a first reference pitch knot point (K=1) and a second reference pitch knot point (K=2) of the ankle joint unit 165 to uniformize an amount of impact absorbed by the ankle joint unit 165 and then connecting the first reference pitch knot point (K=1) and the second reference pitch knot point (K=2) of the ankle joint unit 165 by a spline.

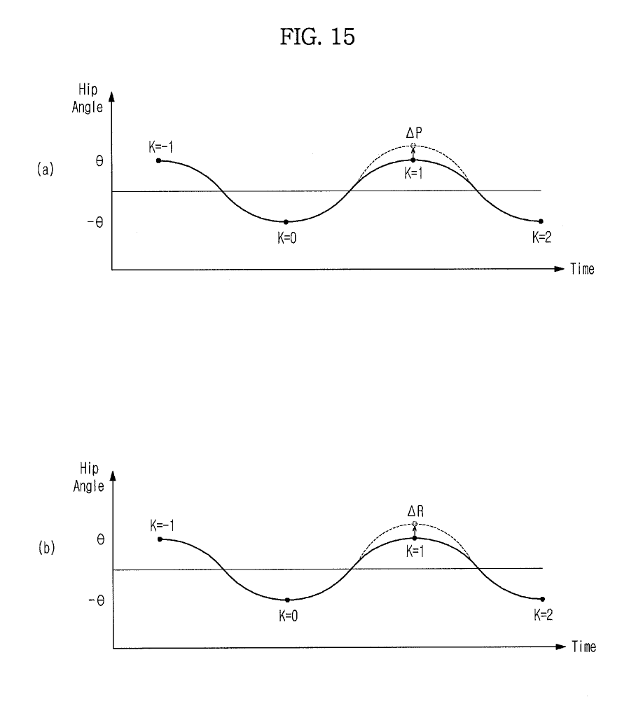

FIG. 15(a) illustrates a target pitch angle trajectory obtained by compensating for reference pitch knot points with a pitch knot compensation value and FIG. 15(b) illustrates a target roll angle trajectory obtained by compensating for reference roll knot points with a roll knot compensation value.

As shown in FIG. 15(a), target pitch knot points of the hip joint unit 163 in the next step (K=1) are generated by compensating for reference pitch knot points of the hip joint unit 163 of a leg, which will swing in the next step (K=1), with the pitch knot point compensation value ΔP in the current step (K=−1), and a target pitch angle trajectory of the hip joint unit 163 of the leg, which will swing, is generated by connecting the generated target pitch knot points by a spline.

As shown in FIG. 15(b), target roll knot points of the hip joint unit 163 in the next step (K=1) are generated by compensating for reference roll knot points of the hip joint unit 163 of the leg, which will swing in the next step (K=1), with the roll knot point compensation value ΔR in the current step (K=−1), and a target pitch angle trajectory of the hip joint unit 163 of the leg, which will swing, is generated by connecting the generated target pitch roll points by a spline.

As described above, the walking velocity of the robot may be easily changed by adjusting at least one of a step length and a step time of one step during walking of the robot. That is, the walking velocity of the robot may be increased by increasing the amplitude of the pitch trajectory of the hip joint unit to increase the step length or by decreasing the step time.

Further, knot points, which are angle commands of the joint units of the respective legs to perform the next step, are compensated for based on the COM of the robot, and the compensated target knot points are connected by splines, thereby allowing the robot to have a natural gait maximally similar to that of a human.

Moreover, knot points in the next step are predicted and adjusted by performing feedback of angles of the joint units in the middle of the current step to maintain balance during walking of the robot, thereby allowing the robot to perform flexible and stable walking.

As is apparent from the above description, a walking control apparatus and method of a robot in accordance with an embodiment changes a walking velocity of the robot by adjusting at least one of a step length and a step cycle, thereby being capable of rapidly and easily adjusting the walking velocity of the robot. Thus, efficiency in development of a walking algorithm may be increased.

Further, the walking control apparatus and method of a robot in accordance with an embodiment performs walking of the robot through FSM control and torque servo control and thus does not need to precisely control rotating angles of respective joints, thereby allowing the robot to walk with a low servo gain to reduce energy consumption and to achieve a high level of safety.

Further, the walking control apparatus and method of a robot in accordance with an embodiment allows the robot to walk with a low servo gain and thus causes the respective joints to have low rigidity, thereby reducing impact applied to the robot during colliding with surroundings.

Further, the walking control apparatus and method of a robot in accordance with an embodiment allows the robot to stretch out its knees during walking in the same manner as walking of humans, thereby improving friendliness of the robot with humans and saving energy consumed when bending the knees of the robot.

Further, the walking control apparatus and method of a robot in accordance with an embodiment compensates for knot points, which are angle commands of the joint units of the respective legs to perform the next step, based on the COM of the robot, and connects the compensated target knot points by splines, thereby allowing the robot to have a natural gait maximally similar to that of a human.

Moreover, the walking control apparatus and method of a robot in accordance with an embodiment predicts and adjusts knot points in the next step by performing feedback of angles of the joint units in the middle of the current step to maintain balance during walking of the robot, thereby allowing the robot to perform flexible and stable walking. Thus, efficiency and performance in walking of the robot may be improved.

The embodiments can be implemented in computing hardware and/or software, such as (in a non-limiting example) any computer that can store, retrieve, process and/or output data and/or communicate with other computers. For example, walking control apparatus 200 in FIG. 3 may include a computer to perform calculations and/or operations described herein. A program/software implementing the embodiments may be recorded on non-transitory computer-readable media comprising computer-readable recording media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A walking control apparatus of a robot comprising:
an input unit to receive a walking velocity of the robot;
hip joint units respectively provided on legs of the robot;
a pose detection unit to detect a pose of the robot;
a walking state judgment unit to judge a walking state from the detected pose of the robot;
a target angle trajectory generation unit to confirm a swing leg and a support leg of the robot based on the judged walking state, to generate reference knot points of the hip joint unit of the swing leg based on the walking velocity, and to generate target angle trajectories of the hip joint unit of the swing leg using the generated reference knot points;
a torque calculation unit to calculate torques tracking the generated target angle trajectories; and
a control unit to output the calculated torques to the hip joint unit of the swing leg to control the walking velocity of the robot.

2. The walking control apparatus according to claim 1, wherein the target angle trajectory generation unit determines a first angle of the hip joint unit of the swing leg when the foot of the swing leg leaves the ground and a second angle of the hip joint unit of the swing leg when the foot of the swing leg contacts the ground based on the walking velocity, sets the first angle to be a first reference pitch knot point of the hip joint unit of the swing leg and sets the second angle to be a second reference pitch knot point of the hip joint unit of the swing leg.

3. The walking control apparatus according to claim 2, further comprising a center of mass (COM) detection unit to detect the COM of the robot,
wherein the target angle trajectory generation unit calculates an offset angle based on the first angle and the detected COM, and respectively reflects the offset angle in the first reference pitch knot point of the hip joint unit of the swing leg and the second reference pitch knot point of the hip joint unit of the swing leg.

4. The walking control apparatus according to claim 3, further comprising a knot point compensation value calculation unit to calculate a pitch knot point compensation value of the hip joint unit of the swing leg by judging a variation of the detected COM in the X-axis direction and comparing the judged variation of the detected COM in the X-axis direction with a reference variation of the COM in the X-axis direction,
wherein the target angle trajectory generation unit generates target pitch knot points by compensating for the first reference pitch knot point and the second reference pitch knot point, in which the offset angle is reflected, with the pitch knot point compensation value.

5. The walking control apparatus according to claim 3, further comprising ankle joint units respectively provided on the legs of the robot,
wherein the target angle trajectory generation unit generates a first reference pitch knot point and a second reference pitch knot point of the ankle joint unit of a respective leg of the robot based on an angle of the ankle joint unit of the respective leg when the robot stands erect, the first angle, the second angle and the offset angle, and generates a target pitch angle trajectory of the ankle joint unit of the respective leg by connecting the first reference pitch knot point and the second reference pitch knot point of the ankle joint unit of the respective leg by a spline.

6. The walking control apparatus according to claim 2, wherein the target angle trajectory generation unit generates a target pitch angle trajectory of the hip joint unit of the swing leg by connecting the first reference pitch knot point and the second reference pitch knot point of the hip joint unit of the swing leg by a spline, and adjusts a cycle of the target pitch angle trajectory of the hip joint unit of the swing leg based on the walking velocity.

7. The walking control apparatus according to claim 6, wherein:
the cycle of the target pitch angle trajectory of the hip joint unit of the swing leg corresponds to a step time during which one step is performed during walking of the robot; and
an amplitude of the target pitch angle trajectory of the hip joint unit of the swing leg corresponds to a step length of the one step.

8. The walking control apparatus according to claim 1, wherein the pose detection unit includes an FIT detection unit to detect force transmitted to the feet of the robot.

9. A walking control method of a robot comprising:
confirming a swing leg and a support leg of the robot by judging a walking state of the robot when a walking velocity of the robot and a walking command are received by the robot;
generating reference pitch knot points of a hip joint unit of the swing leg based on the judged walking state and the walking velocity of the robot;
generating a target pitch angle trajectory of the hip joint unit of the swing leg using the generated reference pitch knot points;
calculating torques tracking the generated target pitch angle trajectory; and
outputting the torques to the hip joint unit of the swing leg to control the walking velocity of the robot.

10. The walking control method according to claim 9, wherein the generating reference pitch knot points of the hip joint unit of the swing leg includes:
determining a first angle of the hip joint unit of the swing leg when the foot of the swing leg leaves the ground and a second angle of the hip joint unit of the swing leg when the foot of the swing leg contacts the ground based on the walking velocity; and
setting the first angle to be a first reference pitch knot point of the hip joint unit of the swing leg and setting the second angle to be a second reference pitch knot point of the hip joint unit of the swing leg.

11. The walking control method according to claim 10, further comprising:
obtaining an erect standing angle of the hip joint unit of the swing leg under the condition that the robot stands erect; and
reflecting the erect standing angle of the hip joint unit of the swing leg in the first and second reference pitch knot points.

12. The walking control method according to claim 10, further comprising:
storing an offset angle based on the first angle and the center of mass (COM) of the robot in advance; and
reflecting the offset angle, stored in advance, in the first reference pitch knot point of the hip joint unit of the swing leg and the second reference pitch knot point of the hip joint unit of the swing leg.

13. The walking control method according to claim 10, further comprising:
detecting the center of mass (COM) of the robot;
calculating an offset angle based on the first angle and the detected COM; and
reflecting the offset angle in the first reference pitch knot point of the hip joint unit of the swing leg and the second reference pitch knot point of the hip joint unit of the swing leg, respectively.

14. The walking control method according to claim 12, further comprising:
obtaining an erect standing angle of an ankle joint unit of a respective leg of the robot under the condition that the robot stands erect;
generating a first reference pitch knot point of the ankle joint unit of the respective leg based on the erect standing angle of the ankle joint unit of the respective leg, the first angle and the offset angle;
generating a second reference pitch knot point of the ankle joint unit of the respective leg based on the erect standing angle of the ankle joint unit of the respective leg, the second angle and the offset angle; and
generating a target pitch angle trajectory of the ankle joint unit of the respective leg by connecting the first reference pitch knot point and the second reference pitch knot point of the ankle joint unit of the respective leg by a spline.

15. The walking control method according to claim 10, wherein:
the generation of the target pitch angle trajectory of the hip joint unit of the swing leg is carried out by connecting the first reference pitch knot point and the second reference pitch knot point of the hip joint unit of the swing leg by a spline; and
a cycle of the target pitch angle trajectory of the hip joint unit of the swing leg is adjusted based on the walking velocity.

16. The walking control method according to claim 15, wherein:
the cycle of the target pitch angle trajectory of the hip joint unit of the swing leg is adjusted so as to correspond to a step time during which one step is performed during walking of the robot;
an amplitude of the target pitch angle trajectory of the hip joint unit of the swing leg is adjusted so as to correspond to a step length of the one step; and
the control of the walking velocity includes adjusting at least one of the step time and the step length.

17. The walking control method according to claim 9, wherein the generation of the target pitch angle trajectory of the hip joint unit includes:
detecting the center of mass (COM) of the robot;
judging a variation of the detected COM in the X-axis direction;
calculating a pitch knot point compensation value of the hip joint unit of the swing leg by comparing the judged variation of the detected COM in the X-axis direction with a reference variation of the COM in the X-axis direction; and
generating target pitch knot points of the hip joint unit of the swing leg by compensating for the first reference pitch knot point and the second reference pitch knot point with the pitch knot point compensation value.

18. The walking control method according to claim 9, further comprising:
detecting the center of mass (COM) of the robot;
judging a variation of the detected COM in the Y-axis direction;
calculating a roll knot point compensation value of the hip joint unit of the swing leg by comparing the judged variation of the detected COM in the Y-axis direction with a reference variation of the COM in the Y-axis direction;
generating reference roll knot points of the hip joint unit of the swing leg in the next step based on the walking state of the robot; and
generating target roll knot points of the hip joint unit of the swing leg by compensating for the reference roll knot points with the roll knot point compensation value.

19. The walking control method according to claim 9, further comprising generating reference roll knot points and reference pitch knot points of the hip joint unit of the support leg which will support the ground.

20. The walking control method according to claim 19, further comprising:
detecting the center of mass (COM) of the robot;
judging a variation of the detected COM in the X-axis direction;
calculating a pitch knot point compensation value based on the judged variation of the detected COM in the X-axis direction;
calculating a roll knot point compensation value based on a variation of the COM in the Y-axis direction;
generating target roll knot points of the hip joint unit of the support leg by compensating for the reference roll knot points with the roll knot point compensation value; and
generating target pitch knot points of the hip joint unit of the support leg by compensating for the reference pitch knot points with the pitch knot point compensation value.

21. The walking control method according to claim 9, wherein said judging a walking state includes:
detecting load of feet of the robot;
judging a leg, the load of which is detected, to be the support leg which contacts the ground; and
judging a leg, the load of which is not detected, to be the swing leg which does not contact the ground.
